(19) United States
(12) Patent Application Publication
(10) Pub. No.: US 2006/0085914 A1
(43) Pub. Date: Apr. 27, 2006

(54) Adjustable bed for bariatric patients

(76) Inventors: Steve Peterson, Placitas, NM (US); Jason R. Richardson, Brandon, MS (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/151,697

(22) Filed: Jun. 13, 2005

Related U.S. Application Data
(60) Provisional application No. 60/579,226, filed on Jun. 14, 2004.

(51) Int. Cl. A47C 21/08; A61G 7/018

(52) U.S. Cl. 5/618; 5/662; 5/430

(57) ABSTRACT

An adjustable bed having a frame and a mattress support including a head section, center section, and foot section. The head section and foot section are pivotally attached to the center section for raising and lowering. At least one sidearm railing is preferably attached to the side of the bed. A pair of adjustable egress poles are attachable to each side of the mattress and extend upward from the mattress support deck to a height such that when the backrest section is raised to move the bariatric patient from a supine to a seated position in the bed and the lower extremity section is lowered to permit the bariatric patient to place their feet on the floor. The patient can grasp an upper portion of each pole in a respective hand to assist the patient in exiting the bed from the foot end of the bed.

### PRIORITY APPLICATION

This application claims the benefit of U.S. Provisional Application Ser. No. 60/579,226, filed Jun. 14, 2004, which is incorporated herein by reference.

### FIELD OF THE INVENTION

The present invention relates generally to hospital beds, and more particularly to an improved adjustable bed for bariatric patients.

### BACKGROUND OF THE INVENTION

Bariatric patients typically weigh between 300 and 700 pounds. As a result, existing hospital beds are typically not sufficiently sturdy to support these weights. Bariatric beds have been developed for use by bariatric patients. Bariatric beds typically include a very heavy duty frame and side rails which can be pivoted outwardly to accommodate large patients.

Gastric bypass surgery is an increasingly popular procedure for bariatric or morbidly obese patients. Upon completion of the surgery, it is desirable for the patient to be ambulatory within 6 to 8 hours of the operation. This often requires the patient to stress his or her abdominal muscles while hospital personnel assist the patient out of the bed.

Attempting to assist a bariatric patient out of bed and assume a standing position requires substantial strength on the part of an assisting nurse or orderly. Such personnel are often faced with the problem of over-exerting themselves in assisting such a patient. Back strain is a common complaint among nurses for this reason. An alternative is for the nurse to call upon stronger orderlies to help, but they may not be readily available when the patient needs to get out of bed.

Traditionally, patients have exited a hospital bed from the side thereof. This method of exiting a bed is especially difficult for obese patients following abdominal surgery. For example, the patient must be rotated 90 degrees so the patient's feet are extending off the side of the bed. Next, it is necessary for the patient to sit upright from a supine position. Even with the assistance of hospital personnel, the transition from a supine position to a sitting position can cause strain to the abdominal muscles if the patient's back is not adequately supported.

There are various examples of adjustable beds that have been designed for bariatric patients in the known prior art. For example, U.S. Pat. No. 4,409,695 of Johnston et al. is directed to an adjustable bed for the care of morbidly obese patients. It comprises a backrest, a center section and a lower extremity section that are hingedly interconnected and have power devices which selectively raise the head and lower extremity section relative to the center section.

U.S. Pat. No. 4,787,104 to Grantham is directed to a bed that is convertible to an easy chair. Conversion occurs by moving an upper frame and the mattress longitudinally toward the foot of the bed while elevating the upper body portion of the movable frame to form the back of the chair. As the frame moves toward the foot, the lower portion, together with the portion of the mattress thereon, is drawn back underneath the bed and out of the way from interfering with the patient sitting in the chair configuration with his or her feet on the floor.

U.S. Pat. No. 6,694,557 to Bobey et al., entitled “Bariatric Bed” is directed to a low air loss bladder coupled to a siderail. The bed includes pivotable siderails on opposite sides of the bed. The siderails are pivotable relative to a frame in an outward pivoted position to accommodate large patients on the bed.

U.S. Pat. No. 6,725,474 to Foster et al. is directed to a hospital bed wherein the patient support platform is movable between a bed position in substantially parallel relationship with the seat section and chair position with the leg section rotated downward relative to the seat section. The mattress defines a footprint projected downward on a floor surface when the patient support platform is in the bed position. Movement of the leg section of the patient support platform uncovers a portion of the footprint that remains located between perimeter portion of the frame after said movement.

Other prior art bariatric beds include the Maxi Rest Bariatric Beds and Bariatric Stretcher Beds marketed by Gendron, Inc. of Archbold, Ohio.

The known prior art does not address the unique needs of bariatric patients following abdominal surgeries such as gastric bypass surgery. Specifically, the prior art does not adequately allow a post-operative patient to independently move from a supine position to an upright position standing on the floor without straining the patient's abdominal muscles. Accordingly, there exists a need for an improved adjustable bariatric bed that facilitates aggressive patient recovery while promoting a sense of stability and dignity for the patient.

### SUMMARY OF THE INVENTION

In one embodiment of the invention, a lower extremity section lowering system for a bariatric bed is disclosed. The lower extremity section lowering system is designed to facilitate aggressive patient recovery by allowing a patient a full frontal exit of the bed that is both safe and promotes a sense of stability and dignity for the patient. This is accomplished due to the unique design that allows the lower extremity section of the bed to lower while raising the backrest to an elevated angle. Accordingly, the patient is located in a full-seated position which allows the patient to self-ambulate without compromising the safety of the patient. Once in a seated position, the patient is able to use a pair of adjustable egress poles to pull themselves into a standing position. Unlike conventional bariatric chairs, the present invention can also be used as an acute care bed because it provides for all the necessary functions to serve in an acute care bariatric setting, as well as a rehabilitation setting.

In another embodiment, an adjustable bed includes a ground engaging frame and a deck pivotally mounted to the frame. The deck includes a backrest, a center section, and a lower extremity section, each having opposite sides. The backrest and lower extremity section are pivotally attached to the center section for respective relative raising and lowering. At least one sidearm is attached to the backrest at a side thereof. The sidearm has a remote end adapted for providing support to confine a patient on the bed. At least one sidearm is attached to the center section at a side thereof. The sidearm has a remote end adapted for providing support to confine a patient on the bed. At least one handle is disposed on an end member, the end member is attached to the deck by a extender.

In yet another embodiment of the invention, an adjustable bed is disclosed comprising a floor engaging frame and a deck pivotally mounted to the frame. The deck includes a backrest capable of rotating from a position substantially parallel to the deck to a position substantially perpendicular to the floor. A center section is attached to the deck. A lower extremity section is capable of rotating from a position substantially parallel to the deck to a position substantially perpendicular to the floor, whereby, the backrest and lower extremity section are pivotally attached to said center section for respective rotation. At least one sidearm is attached to the backrest at a side thereof. The sidearm has a remote end adapted for providing support to confine a patient on the bed. At least one sidearm is attached to the center section at a side thereof. The sidearm has a remote end adapted for providing support to confine a patient on the bed. A first handle is disposed on a first end member. The first end member is attached to the deck by a first extender. A second handle is disposed on a first end member. The first end member is attached to the deck by a first extender.

### BRIEF DESCRIPTION OF THE DRAWINGS

FIG. 1 is a perspective view of an adjustable bed incorporating the present invention.

FIG. 2 is a perspective view of an adjustable bed incorporating the present invention and with the backrest in the upright position and the lower extremity section in the lowered position.

FIG. 3 is a front view of an adjustable bed incorporating the present invention and with the backrest in the upright position and the lower extremity section in the lowered position.

FIG. 4 is a front perspective view of the frame of the adjustable bed.

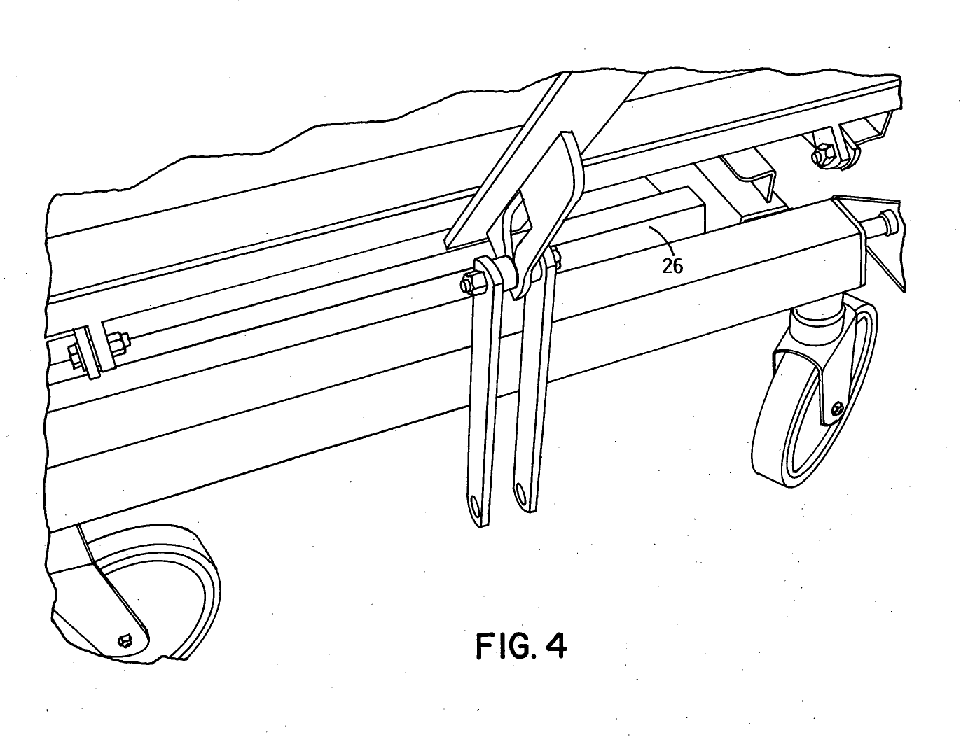

FIG. 5 is a front perspective view of the lower extremity section of the adjustable bed.

FIG. 6 is a front perspective view of the lower extremity section of the adjustable bed.

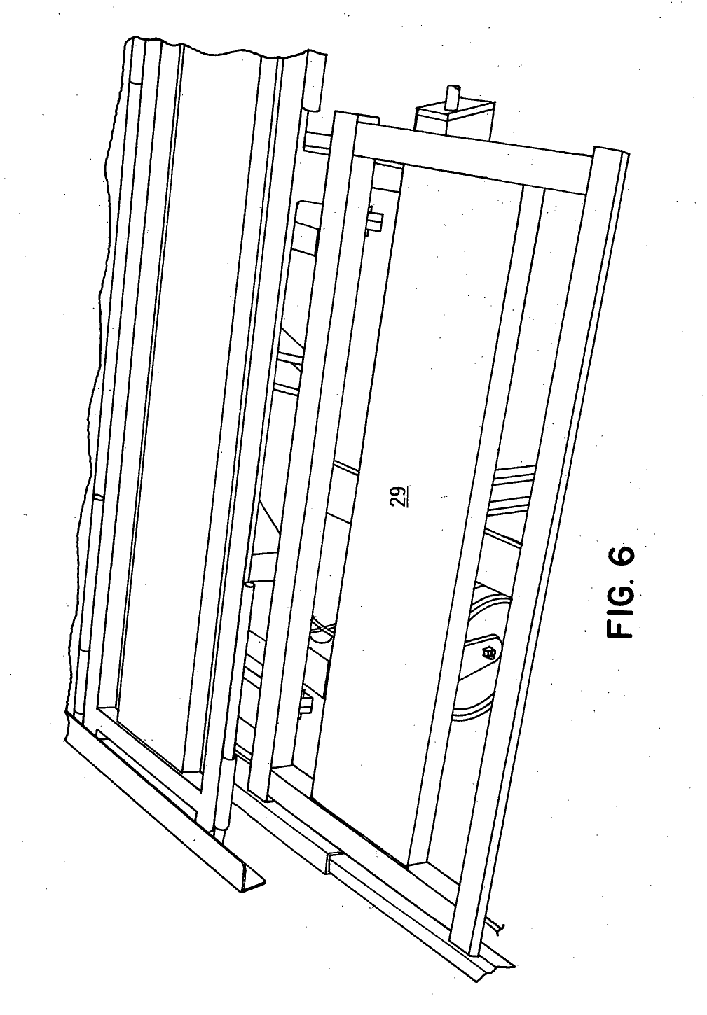

FIG. 7 is a front perspective view of the lower extremity section of the adjustable bed.

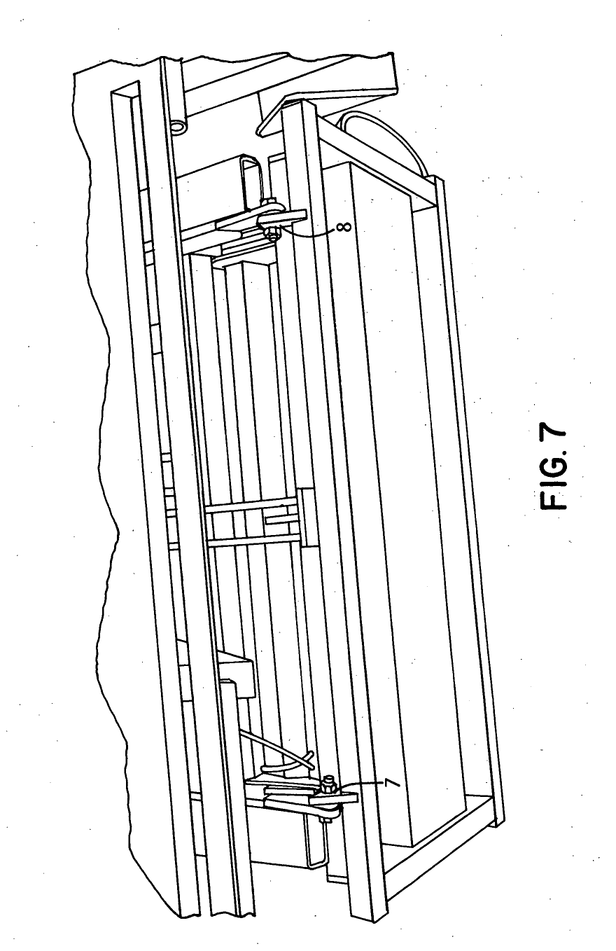

FIG. 8 is a front perspective view of the lower extremity section of the adjustable bed.

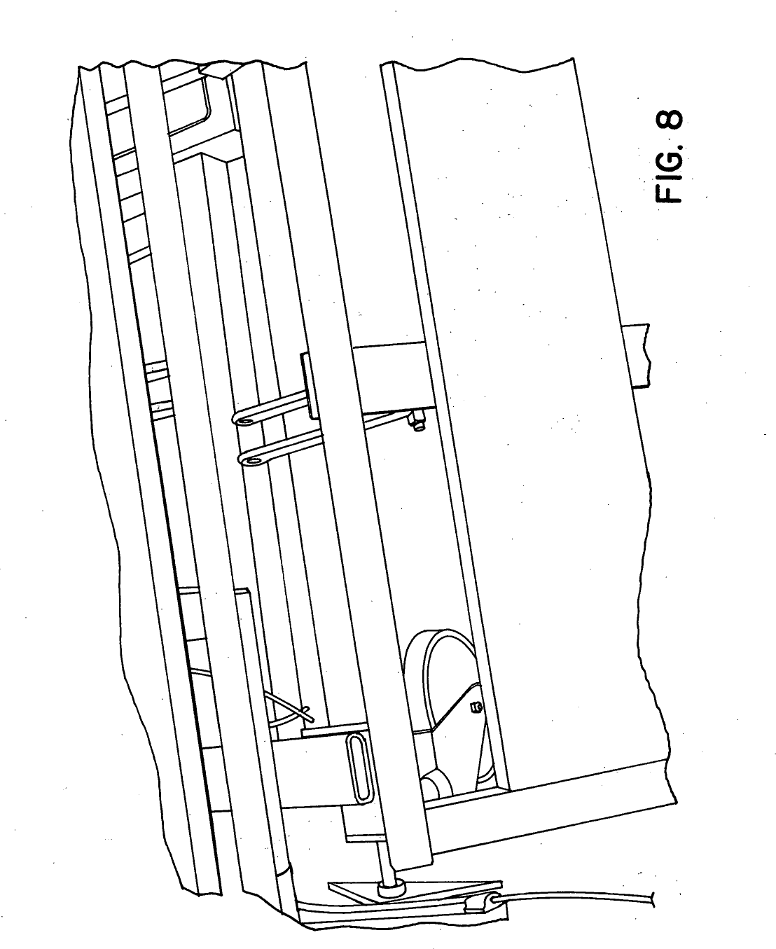

FIG. 9 is a perspective view of an adjustable bed including a controller mounted to the side of the bed.

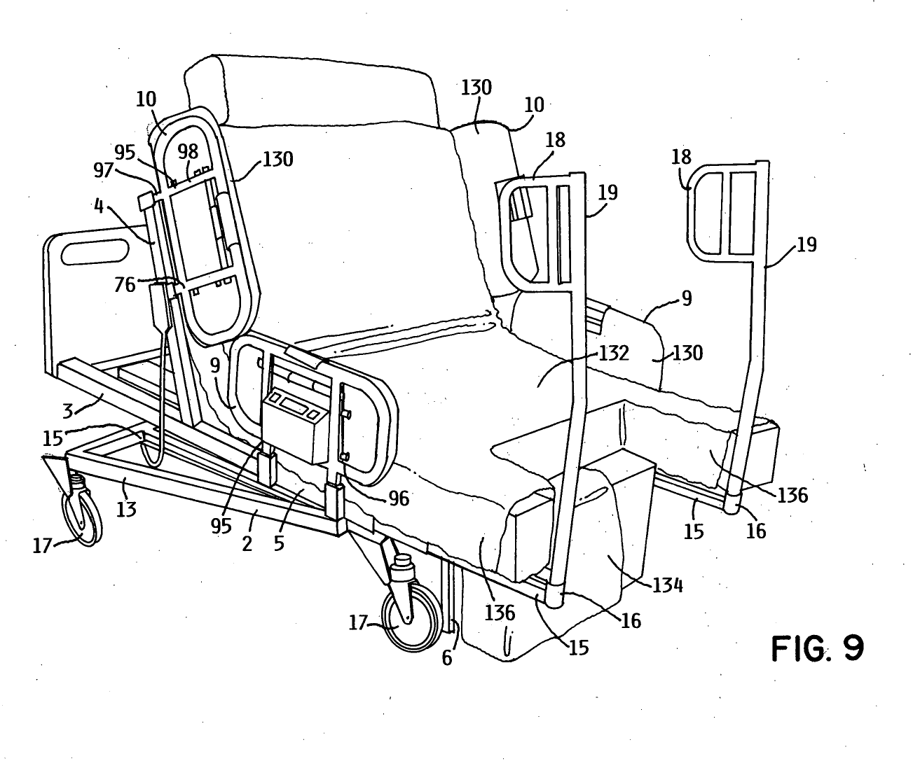

FIG. 10 is a perspective view of an adjustable bed incorporating the present invention with the side arms in a rotated position.

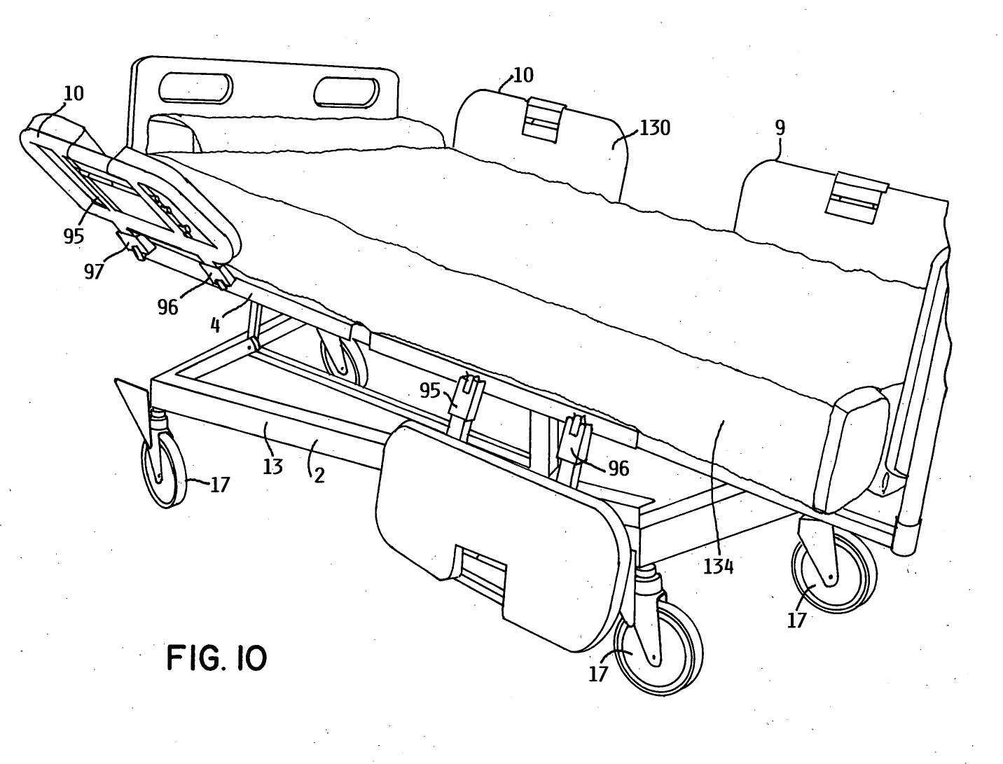

### DETAILED DESCRIPTION OF THE INVENTION

The preferred embodiment of the present invention will be described with respect to the various figures. In the preferred embodiment, the features and aspects of the present invention are incorporated into the design of an existing bariatric bed, such as the Maxi Rest Bariatric Beds and Bariatric Stretcher Beds available from Gendron, Inc., for which the details or operation and construction are incorporated herein by reference. It will be understood, however, that the present invention may be incorporated into any number of designs for a bariatric bed for either existing beds or for newly designed bariatric hospital beds.

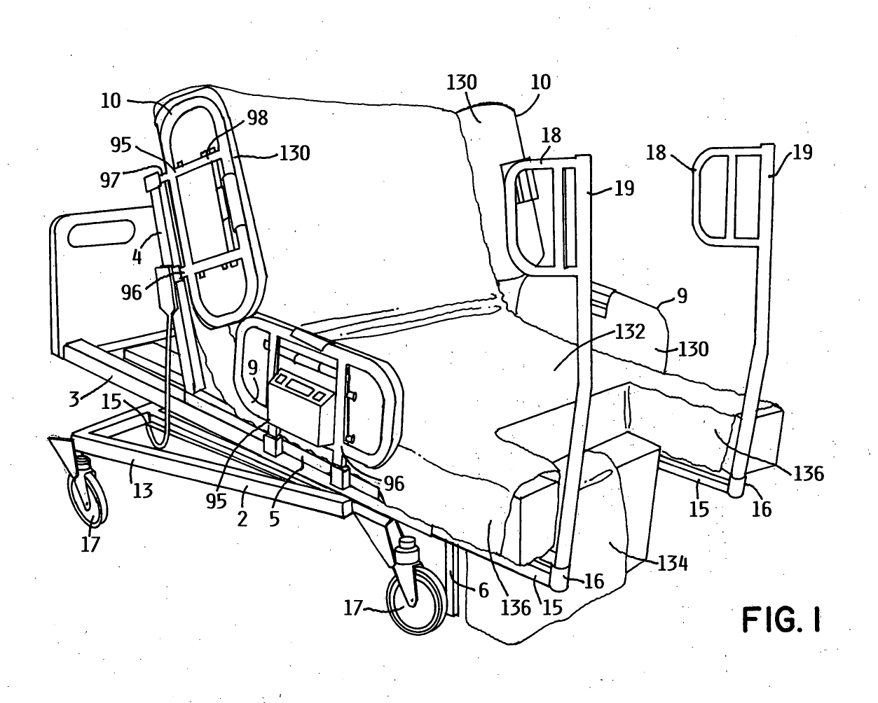

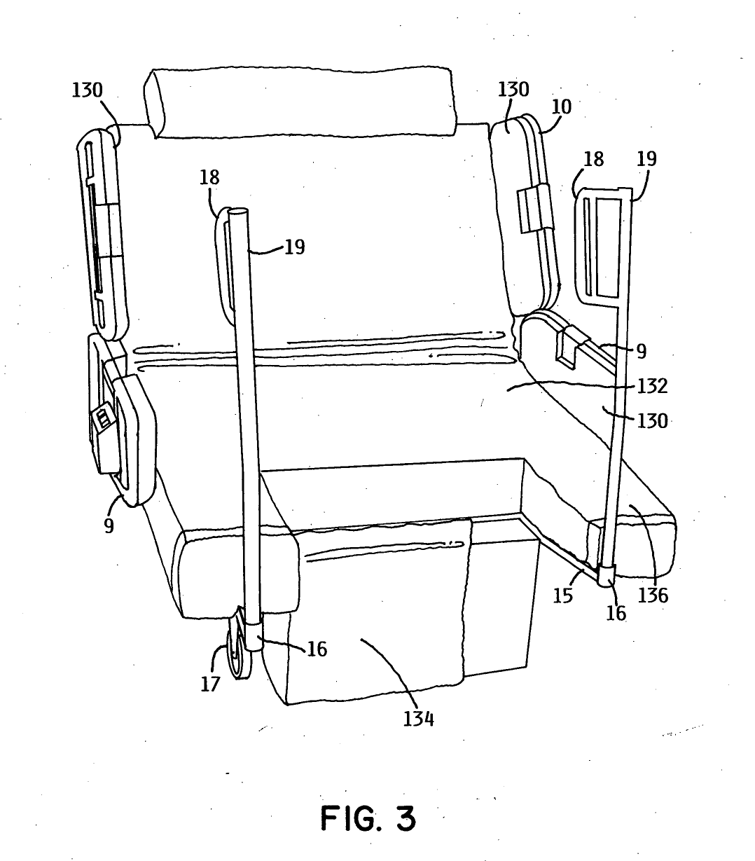

With reference to FIGS. 1-3 an adjustable bed is shown embodying the present invention. The adjustable bed 1 comprises a floor engaging frame 2 and a deck 3. Deck 3 is pivotally connected to frame 2 and capable of allowing support 3 to rotate with respect to frame 2.

Deck 3 includes a center section 5 and a backrest 4 pivotally interconnected to the center section 5. This configuration enables backrest 4 to rotate at an angle with respect to the floor, thereby enabling a patient to sit on bed 1 in an upright position. In a preferred embodiment, deck 3 is movable from a low position of 19.5″ to a high position of 29″. Moreover, backrest 4 is capable of rotating at least 45 degrees with respect to the floor, more preferably, at least 60 degrees with respect to the floor, preferably in by powered operation of a of the deck 3 as described below.

Side arms 9 are preferably pivotally connected to opposite sides of the center section 5 and include rotation locking means to confine a patient on the bed 1 and to selectively provide additional restive area. Similarly, side arms 10 are pivotally connected to opposite sides of the backrest 4. Side arms 10 also include rotation locking means to confine a patient on the bed 1.

Lower extremity section 6 is pivotally connected to deck 3 at hinge 7 and hinge 8. Lower extremity section 6 is capable of rotating approximately 90 degrees from a position that is substantially parallel to the floor to a position that is substantially perpendicular to the floor. This configuration permits the lower extremity section 6 to swing clear of a patient when the bed 1 is tilted from a horizontal position to a vertical position. This configuration defines a full frontal exit system, which enables a patient to egress from the bed 1 in an independent, dignified manner. The system also provides for a high level of security and stability because the patients feet can easily be positioned firmly on the floor while the patient supports himself with handles 18.

The frame 2 is a stationary, ground engaging structure adapted to support the patient and the deck 3 above the ground or floor surface. Frame 2 includes a pair of parallel, longitudinally extending side rails 13 which are interconnected by laterally extending cross members 15. Wheels 17 are pivotally attached to opposite ends of the side rails 13. The wheels 17 are preferably provided with brakes to selectively prevent inadvertent movement of bed 1 over the floor surface. In a preferred embodiment, wheels 17 comprise 8″ diameter casters with two wheel locks operated at head and foot. This configuration permits patients to be easily moved from room to room with minimal effort.

A pair of upright egress poles 19 are attached to the deck 3 at receiver 16. Egress poles include handles 18 to help a patient into or off of bed 1 and to facilitate movement of the bed 1. Receivers 16 have open lower ends that enable egress poles 19 to be adjusted with respect to receivers 16 to facilitate movement of the patient. Extenders 15 are telescopically connected to deck 3 and allow the distance between handles 18 and side arms 9 to be adjusted. Extenders 15 are capable of adjusting the length of the bed, preferably from about 80 inches to 90 inches.

In a preferred embodiment, lower extremity section 6, is capable of being positioned between extenders 15. Lower extremity section 6, is capable of moving in a downward position to a sufficient angle of comfort. When the lower extremity section 6 is substantially perpendicular to the floor, a patient can stand between extenders 15 while grasping handles 18. This configuration further assists a patient from egressing from the bed 1.

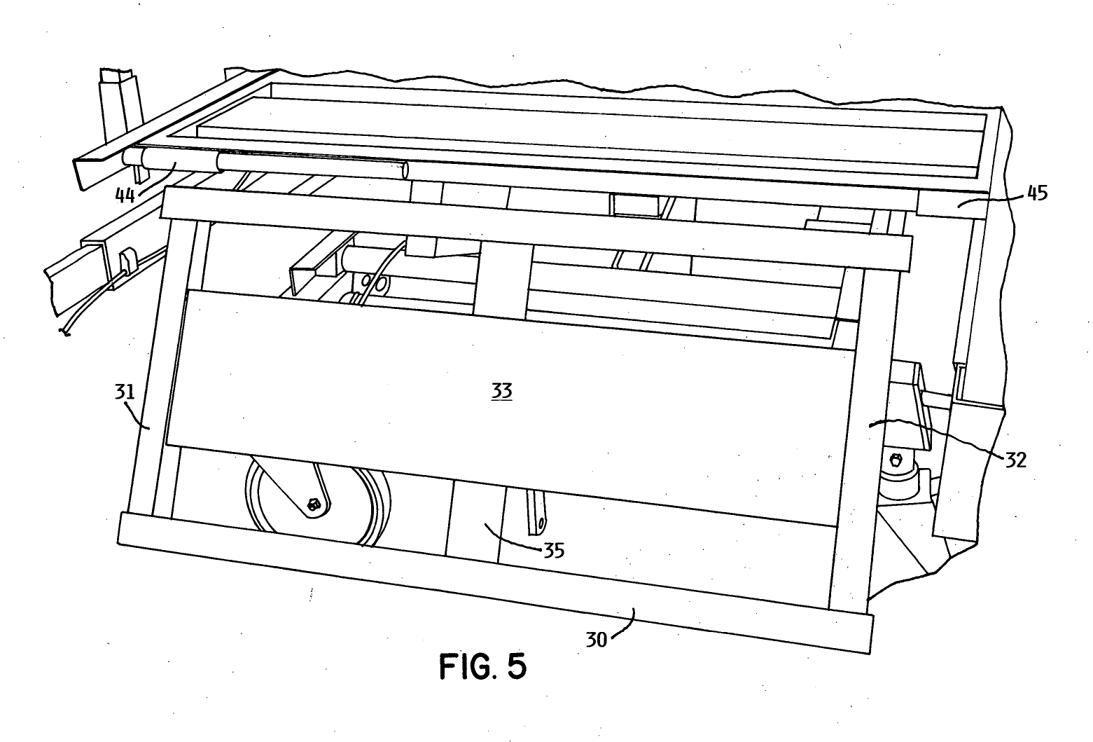

Each of the sections 4, 5 and 6 have a generally rectangular shape. As shown in FIG. 5, lower extremity section 6 includes a rigid, peripheral frame 30 including side members 31 and 32. A plate 33 is disposed in the interior of peripheral frame 30, and is preferably fastened to side members 31 and 32 so that plate 33 will not interfere with the comfort of the bed. For example, welds may be disposed along the frame 30 on the interior side of plate 33. Medial brace member 35 is shown parallel to and midway between side member 31 and side member 32. Medial brace member 35 provides additional support for plate 33. Each of the sections 4, 5 and 6 also includes a plate 33 and a medial brace member 35 extending between the side members 31 and 32 of the respective frames 30.

The entire interconnected deck 3 is able to rotate with respect to the frame 2 by hinges 44 and 45, as shown in FIG. 5. This enables deck 3 to move to an inclined position with respect to frame 2. Frame 2 and deck 3 are preferably fabricated from a rigid material such a steel or aluminum. Although a variety of materials may be used while remaining within the scope of the invention. In a preferred embodiment, frame 2 and deck 3 are capable of providing maximum stability while moving a patient from surgical recovery ward to hospital room, thereby reducing the amount of unnecessary patient transfers.

In one embodiment, bed 1 is able to support a patient weighing at least 600 pounds, more preferably 700 pounds. In a preferred embodiment, bed 1 is able to support 1000 pounds.

The adjustable bed 1 has standard size transverse dimensions to accommodate passage through a normal width hospital door. In a preferred embodiment, the width of deck 3 is expandable from 39″ to 48″ to 54″. In another embodiment, the width of deck 3 is expandable from 36 to 54 inches.

In one embodiment, lift means extend between the frame 2 and the head and lower extremity sections 4 and 6 for tilting the head and lower extremity sections 4 and 6 with respect to the center section 5. Each lift means can include a 24 volt linear actuator with emergency battery backup. The motors are operable in either rotational direction to raise or lower sections 4 or 6. Thus, operation of the respective lift means at the head and lower extremity sections 4 and 6 causes same to pivot about the respective hinges and move either upwardly or downwardly as selected. Each of the lift means are electrically connected with a circuit arrangement for selectively activating each of the motors and controlling the direction of rotation thereof. Preferably, each lift means is activated by current of 24 volts DC. In a preferred embodiment, a switching controller 58 is provided for operation of the lift means and has push button switches therein for manipulation.

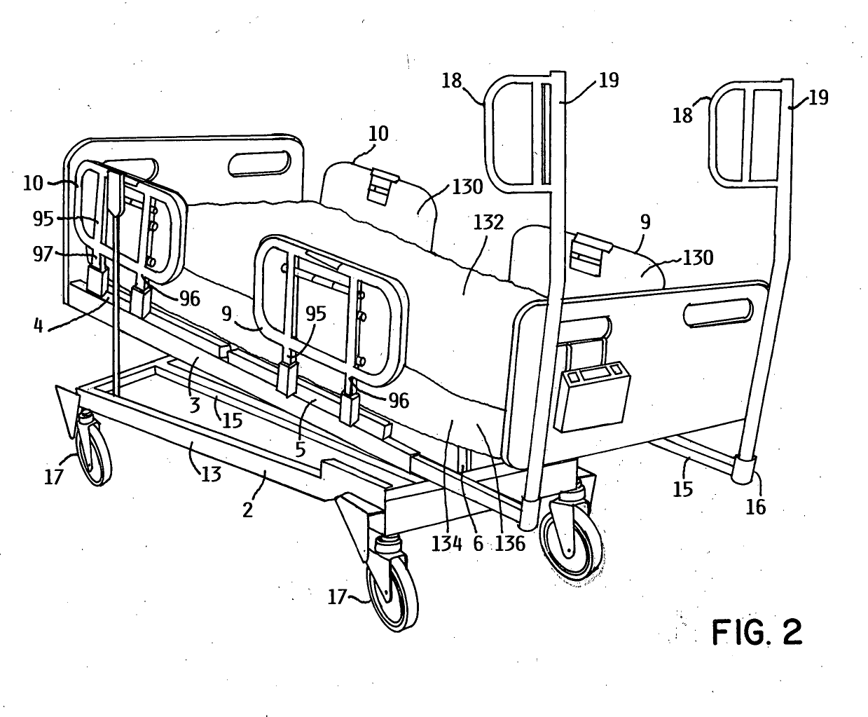

The side arms 9 and 10 are positioned on opposite sides of the center section 5 and backrest 4, respectively, and are rotatable toward and away from the center section 5 for purposes later described. Referring to FIGS. 1 and 2, the side arms each include spaced arm members 95 and 96 respectively having a lower end 97 and an upper end 98. In one embodiment, the lower end 97 may include a pivotal connection to the center section 5 or backrest 4.

A side arm rail 130 is attached to the remote ends 98 of the arm members 95 and 96 to provide a comfortable confining and resting surface for the patient 10. As shown in FIGS. 1 and 2, the side arm rail 130 is an elongated, continuous loop of tubular material affixed to the upper or remote ends 98.

To complete the adjustable bed 1, a two-piece mattress is emplaced and has a combination center and backrest mattress 132 and a lower extremity section mattress 134. Mattresses 132 and 134 may be attached by cloth, or they may be separate. Because of the great bulk of some morbidly obese patients, especially in the hip and shoulder areas, mattress 132 may also include cushioned pads 130 disposed along arms 9 and 10. In a preferred embodiment, lower extremity section mattress 134 is capable of being surrounded on three sides by center backrest mattress 132 when lower extremity section 6 is substantially parallel to center section 5. To accomplish this, center backrest mattress 132 includes legs 136 covering extenders 15.

The mattresses 132 and 134 has been designed to support a patient weight up to 1000 pounds without compromising patient comfort and safety. The mattress 132 and 134 is designed to keep the bariatric patient from bottoming out on sections 4, 5, and 6 and therefore provide a high comfort, wound preventative surface.

The shape of combined mattress sections 132 and 134 is designed to allow the lower extremity section to drop out of the way while still providing an adequate layer of padding protection for the patient on either side of the drop away system. The unique shape of the mattress also allows the surface to be expandable using a set of three bolsters that are attached via a sleeve system that can be easily inserted to widen and lengthen the support surface. It should be noted that the bolster system is designed with openings on both ends to make them easy to install and quick to remove if the bed needs to be removed through a standard side door with the patient onboard the bed 1.

The cover of mattress sections 132 and 134 are made of a four way, non-shearing fluid impervious cover which is both easy to clean and comfortable for the bariatric patient. The cover is also designed to stretch to allow the patient to attain a greater level of immersion in the surface of the mattress to promote healing, comfort and to prevent the patient from unwanted sliding in the bed. Moreover, a micro-contouring surface facilitates better circulation and wound prevention for bariatric patients.

In a preferred embodiment, bed 1 may include an integral weighing scale with preferably a 1000 pound capacity. This scale is movable and can be used in conjunction with the bed 1, limiting the amount of patient transfers needed to obtain essential patient weight measurements. The scale can also be used when the patient is in the seated position and the full supine head position. The scale is also designed to allow the caregiver to zero the scale without the need to remove the patient from the support surface. The integrated scale of this preferred embodiment virtually eliminates the need for an additional bariatric scale system, thereby saving space within the care and treatment areas.

In another feature of the invention, the bed 1 is equipped with a CPR release that is located midway at a patient's head section on left side and right side. To ensure caregiver safety, the release has been enhanced with a 4 second delay. Bed 1 is also be equipped with lock out features to disable the different mobility features of the bed such as trendelenburg, reverse trendelenburg, up, down, leg drop features, or any combination of these positions, thereby ensuring patient safety in any stage of recovery. Bed 1 may also be equipped with a telescopic IV holder, vertical oxygen holder, and IV receptacles at each comer.

A head board 150 and foot board 152 is preferably manually removeably attached to deck 3. Head board 150 and foot board 152 are preferably fabricated from high density polypropylene which can be easily cleaned. Head board 150 and foot board 152 may also include at least one hand hole to facilitate moving the bed from one location to another.

It is to be understood that variations in the present invention can be made without departing from the novel aspects of this invention as defined in the claims.

We claim:

1. An adjustable bed for a bariatric patient, the bed comprising:
a frame;
a mattress support deck operably mounted to the frame, the mattress support deck including a backrest section at a head end, a center section, and a lower extremity section at a foot end, the backrest section and lower extremity section being pivotally attached to the center section, the mattress support deck providing an acute care bed for the bariatric patient in which the mattress support deck is positionable in a fully flat, horizontal orientation;
a motorized system operably coupled to the mattress support deck to selectively raise and lower at least the backrest section relative to the ground;
a pair of adjustable egress poles, each pole operably attached to one side of the mattress support deck proximate the lower extremity section and extending upward from the mattress support deck to a height such that when the backrest section is raised by the motorized system to move the bariatric patient from a supine to a seated position in the bed and the lower extremity section is lowered to permit the bariatric patient to place their feet on the floor, the patient can grasp an upper portion of each pole in a respective hand to assist the patient in exiting the bed from the foot end of the bed, whereby the patient does not turn sideways on the bed to exit the bed and the need for assistance by others in lifting and turning the patient as the patient exits the bed is reduced.

2. The bed of claim 1, further comprising a mattress disposed on the mattress support.

3. The bed of claim 2, wherein the mattress includes a two-piece combination center and backrest mattress and a lower extremity section mattress.

4. The bed of claim 3, wherein the lower extremity section extends across only a portion of a width of the bed and the lower extremity section mattress is generally surrounded on three sides by the center and backrest mattress when the lower extremity section is substantially parallel to the center section.

5. The bed of claim 1, further comprising at least one sidearm railing operably attached to at least the center section.

6. The bed of claim 5, wherein at least one sidearm railing is operably attached to the mattress support deck such that the sidearm railing can be quickly lowered for emergency purposes.

7. The bed of claim 1, wherein each egress pole includes a handle portion proximate an upper end of the egress pole.

8. The bed of claim 1, wherein the motorized system is further arranged to raise and lower the lower extremity section.

9. The bed of claim 5, wherein the egress poles are operably vertically adjustable from a first position in which an upper end of the egress poles is generally no higher than a height of the at least one side arm railing to a second position in which the upper end of the egress poles is generally about shoulder height for the patient in the seated position.

10. The bed of claim 5, wherein the egress poles further comprise an extender portion and are operably horizontally adjustable relative to the at least one side arm railing.

11. The bed of claim 1, further comprising wheels operably coupled to the ground engaging frame.

12. The bed of claim 1, further comprising a removeable foot board selectively engageable with the mattress support deck proximate the foot section of the bed.

13. The bed of claim 1, further comprising a removeable head board selectively engageable with the mattress support deck proximate the head section of the bed.

14. An adjustable bed for a bariatric patient, the bed comprising:
a frame;
deck means for supporting a mattress mounted to the frame to provide an acute care bed for the bariatric patient in which the mattress is positionable in a fully flat, horizontal orientation, the deck means including:
a center section;
a backrest section pivotally attached to the center section at a head end; and
a lower extremity section pivotally attached to the center section at a foot end;
motor means for selectively raising and lowering at least the backrest section relative to the ground;
a pair of egress means for use by the patient hand to assist the patient in exiting the bed from the foot end of the bed without turning sideways, each egress means comprising at least a pole operably attached to one side of the deck means proximate the lower extremity section and extending upward from the deck means to a height such that when the backrest section is raised by the motorized system to move the bariatric patient from a supine to a seated position in the bed and the lower extremity section is lowered to permit the bariatric patient to place their feet on the floor, the patient can grasp an upper portion of each egress means,
whereby the need for assistance by others in lifting and turning the patient as the patient exits the bed is reduced.

15. A method of assisting a bariatric patient to safely exit a bed without straining the patient's abdominal muscles following a medical procedure, the method comprising:
providing an adjustable bed comprising:
a frame having a mattress support deck operably mounted to the frame, the mattress support deck including a backrest section at a head end, a center section, and a lower extremity section at a foot end, the backrest section and lower extremity section being pivotally attached to the center section;
a motorized system operably coupled to the mattress support deck; and
a pair of adjustable egress poles, each pole operably attachable to one side of the mattress support deck proximate the lower extremity section so as to extend upward from the mattress support deck;
positioning the adjustable bed so as to provide an acute care bed for the bariatric patient during the medical procedure in which the mattress support deck is in a fully flat, horizontal orientation;
using the motorized system to raise the head section to a position so the patient is can sit upright in the bed without abdominal strain lowering the foot section so the patent's feet can rest on the floor;
directing the patient to grasp egress poles with opposing hands; and
allowing the patient to apply a pulling force to the egress poles so the patient can stand, and thereby exit from the foot end of the adjustable bed in a safe, and stable manner.
